(19) United States
(12) Patent Application Publication
(10) Pub. No.: US 2015/0040065 A1
(43) Pub. Date: Feb. 5, 2015

(54) METHOD AND APPARATUS FOR GENERATING CUSTOMIZED MENUS FOR ACCESSING APPLICATION FUNCTIONALITY

(71) Applicant: Vonage Network LLC, Holmdel, NJ (US)

(72) Inventors: Itay Bianco, Tel-Aviv (IL); Tzahi Efrati, Hoboken, NJ (US); Baruch Sterman, Efrat (IL); Sagie Machlin, Rishon Lezion (IL); Ido Mintz, Burgata (IL)

(73) Assignee: Vonage Network LLC, Holmdel, NJ (US)

(21) Appl. No.: 13/955,930

(22) Filed: Jul. 31, 2013

(51) Int. Cl. G06F 3/0482

(52) U.S. Cl. CPC G06F 3/0482
USPC 715/810

(57) ABSTRACT

A method for generating customized menus for accessing application functionality of a mobile device comprising detecting a gesture performed on a display of the mobile device and displaying a quick menu on the display containing preview information pertaining to one or more applications based on the detected gesture.

### BACKGROUND OF THE INVENTION

1. Field of the Invention

Embodiments of the present invention generally relate to gesture detection and, more specifically, to a method and apparatus for generating customized menus for accessing application functionality.

2. Description of the Related Art

Mobile devices typically allow you to have a single application running in the foreground. Often, however, a user may want to quickly query some information, without taking the time to open the associated application. This is especially the case if the application has a significant initialization and load time, delaying the user's use of the application. Loading the application may also result in excessive battery consumption. Further, a user may want to directly access a certain functionality or set of items in a given application, such as a specific book, song, or movie without having to wait through excessive initialization delays.

Therefore, what is needed is a way to quickly query and access App-specific information and actions without first having to open the app.

### SUMMARY OF THE INVENTION

The present invention generally relates to a method and apparatus for generating customized menus for accessing application functionality of a mobile device comprising detecting a gesture performed on a display of the mobile device and displaying a quick menu on the display containing preview information pertaining to one or more applications based on the detected gesture.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a detection apparatus in accordance with exemplary embodiments of the present invention;

FIG. 2 is an illustration of the quick menu in use on a mobile device 200 according to an exemplary embodiment of the present invention;

FIG. 3 depicts a computer system in accordance with at least one embodiment of the present invention; and

FIG. 4 is a flow diagram depicting a method for generating customized menus for accessing application functionality in accordance with exemplary embodiments of the present invention.

### DETAILED DESCRIPTION

The present invention relates to generation of a customized menu, or quick menu, for accessing application functionality. A gesture detection application will execute atop an operating system and register gestures performed on a touch screen. The location of the performance of the gesture is determined, and a quick menu is generated based on the application upon which the gesture was performed. The quick menu may comprise any functionality built into the application and may be customized by the user.

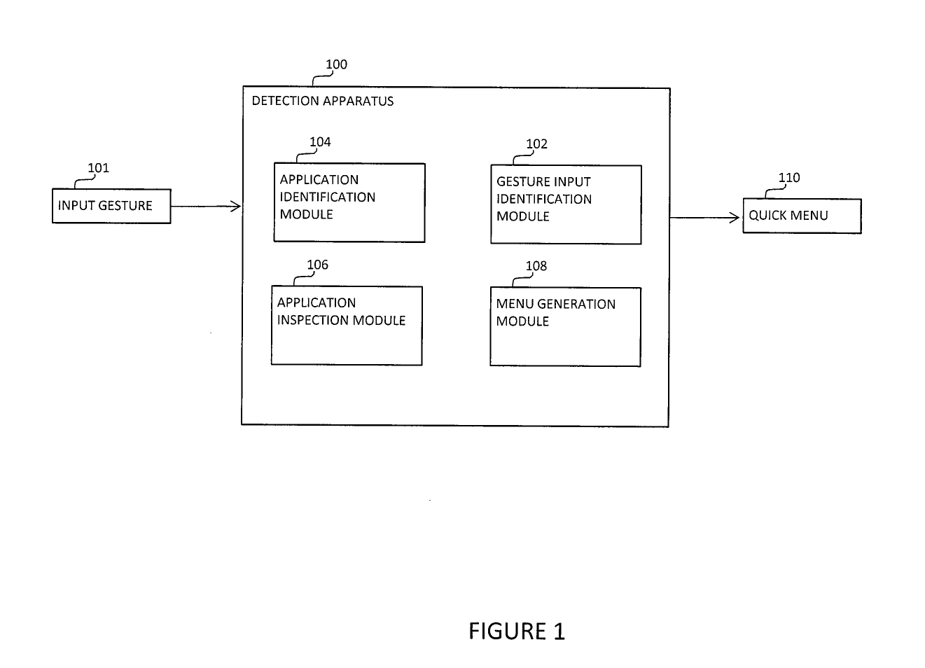

FIG. 1 is a block diagram of a detection apparatus 100 in accordance with exemplary embodiments of the present invention. The detection apparatus 100 comprises a gesture input identification module 102, an application identification module 104, an application inspection module 106 and a menu generation module 108.

The detection apparatus 100 detects gestures performed on a display, for example, a touch screen display. An input gesture 101 is detected on the touch screen display by the detection apparatus 100. The gesture input identification module 102 identifies the gesture information, for example, position location of the start and end point of the input gesture 101. According to one embodiment, the start and end point of the input gesture 101 are identified as using x and y coordinates on the two-dimensional plane of the touch screen display. Those of ordinary skill in the art will recognize that gesture recognition is well known in the art and many different techniques can be used to identify gestures, their origins and the applications or widgets upon which they are performed or intended to be directed towards. Accordingly, gestures may be performed with multiple fingers, or comprise a combination of input gestures and device tilting, rotation or the like. Those of ordinary skill in the art would recognize that the present application allows for any gesture to be recognized by the gesture input identification module 102

Once the gesture input identification module 102 has determined the (x, y) coordinates of the start and end points identifying the location of the input gesture 101, the application identification module 104 determines whether an application icon coincides with the start point of the identified gesture location. If the start point input gesture 101 originates at the same location as an application icon, the application identification module 104 determines which application is associated with the identified application icon.

The application inspection module 106 then inspects the application identified by the application identification module 104 to determine whether the application has functionality which may be previewed without accessing or launching the application. According to one embodiment, the application exposes an application programming interface allowing the application inspection module 106 to inspect “public” or “exposed” functionality. In this embodiment, the application is not required to be fully activated and may be running in a power save mode. According to another embodiment, an applicant can update a file or a shared memory location with exposed application functionality. For example, if the application happens to be an email application, the email application may have exposed or made public (by, for example, writing to a common file) an interface for accessing the most recently received emails, most common email contacts, and the like.

The application inspection module 106 couples the exposed functions to the menu generation module 108. According to some embodiments, the menu generation module 108 calls the publicly exposed functions of the application identified by the application identification module 104, and collects the results of each function call into a quick preview list. In other embodiments, the menu generation module 108 simply collects the exposed functions and creates a quick preview list containing the names of the exposed functions. The menu generation module 108 then generates a quick menu 110 using the quick preview list where the input gesture 101 was made. In other embodiments, the quick menu 110 may appear adjacent to the identified application, or in a location specified by a user through device or application settings.

According to some embodiments, once the input gesture 101 is detected by the detection apparatus 100 on a touch screen, the menu application inspection module 106 is directly invoked. If the application inspection module 106 is not supplied with a specific application, the application inspection module 106 inspects all installed applications on a device for publicly exposed application functionality. The menu generation module 108 then composes a list of the publicly exposed functions and generates a quick menu 110 for displaying the list on a display. According to some embodiments, only those functions which a user has previously selected are shown in the quick menu 110. According to other embodiments, the user may configure a list of applications which the application inspection module 106 may inspect for public functionality. According to yet another embodiment, the application inspection module 106 only inspects the most used applications on a device for public functionality.

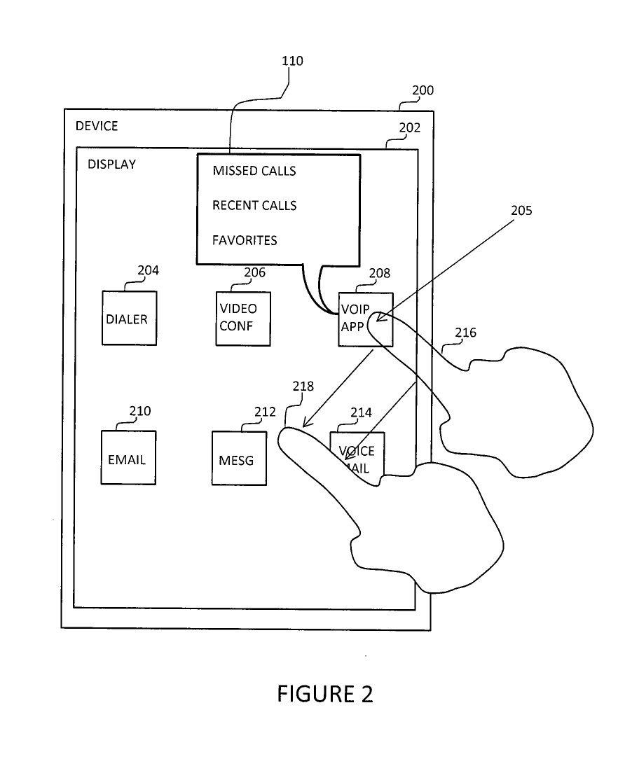

FIG. 2 is an illustration of the quick menu 110 in use on a mobile device 200 according to an exemplary embodiment of the present invention. The device 200 comprises a display 202. Several application icons may be rendered on the display 202. For example, icons appearing in display 202 comprise dialer 204, video conference call application 206, a voice over internet protocol (VoIP) application 208, an email application 210, a messaging application 212 and voicemail 214. Those of ordinary skill in the art will recognize that the present invention may apply to any combination of applications including those not shown in FIG. 2.

According to an exemplary embodiment, the display 202 is rendered using a mobile operating system, which may be ANDROID, IOS, WINDOWS MOBILE, PALM OS, or the like. Those of ordinary skill will recognize that the present invention may be implemented on any mobile device operating system having the necessary hardware and interacting software components.

A user of the mobile device begins a gesture at a first position 216. The user completes his gesture with his or her hand at a second position 218. The starting point of the gesture in position 216 is determined, by the gesture input identification module 102, to be a first point 205, in terms of the x and y displacement for the display 202. The application identification module 104 determines that the application icon at the first point 205 is an icon for the VOIP APP 208. Consequently, once the application icon is identified as representing VOIP APP 208, the application inspection module 106 inspects the VOIP APP 208 for any publicly exposed functionality. For instance, the VOIP APP 208 may allow previews of “missed calls”, “recent calls” and “favorites”, i.e., most commonly called contacts.

The quick menu 110 is then generated by the menu generation module 108 and displayed on the display 202. As described above, the location and look of the quick menu 110 is customizable. Additionally, the gesture from the first position 216 to the second position 218 may invoke the display of a general quick menu which contains previews of functions across various applications residing on the device 200. Another example of an application may be a e-book reader, a movie viewing application, a web browser or the like. The user may also customize the quick menu 110 to contain links to most recently viewed books, songs, websites, or movies. Other examples of preview items comprise calendar events, mini-games from a single application, mini-applications from a multi-application, call favorites, favorite location destinations (i.e., GPS information) and the like. Those of ordinary skill in the art will recognize that any preview items available to the user from the mobile device operating system, or directly from applications themselves, may populate the quick menu 110. Any item or list of data that is available to the mobile operating system of the device may be customized and added to the quick menu 110 per user preference.

In one embodiment, the mobile operating system is ANDROID. A VoIP widget is installed on the device 200. Tapping the widget without movement from the first position 216 of a finger creates an invisible floating window centered on or near the first position 216. Sliding the finger in any direction is monitored by an application executing in the invisible window. According to the gesture made, e.g., the movement of the finger from the first position 216 to the second position 218, the appropriate data will be rendered to the invisible window. The quick menu 110 may be rendered in the invisible window, for example. A desired item from the quick menu 110 is executed once the user's finger slides to that entry and the finger is removed. In some embodiments the quick menu 110 may contain a “close” icon somewhere within the invisible window. The user may remove their finger from the touch screen while the quick menu 110 remains rendered on the screen and close the quick menu using the close icon. According to some embodiments, the quick menu 110 is displayed for applications executing in the background on the mobile operating system. In other instances, the quick menu 110 may contain a mixture of applications, whether executing in the background or currently not executing.

According to some embodiments, the user may customize the quick menu 110 to contain commonly accessed preview information depending on the user's preference. In some instances, the quick menu 110 may only contain functionality, or preview information, pertaining to one application. In other instances, the quick menu 110 comprises preview information from several different applications.

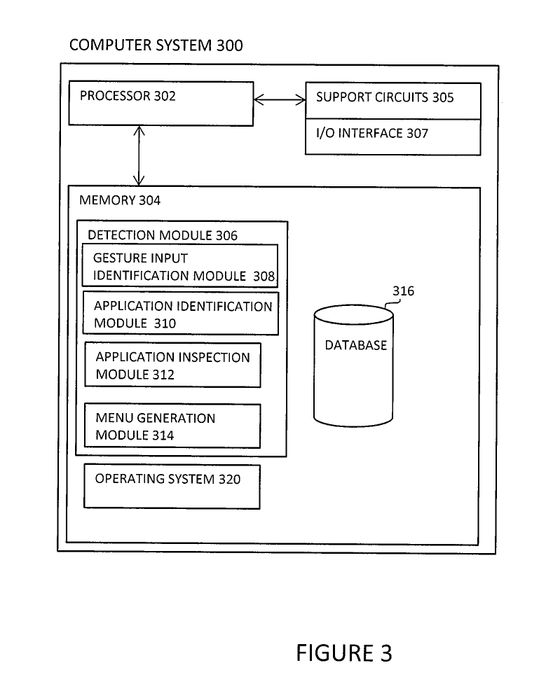

FIG. 3 depicts a computer system 300 in accordance with at least one embodiment of the present invention. The computer system 300 includes a processor 302, various support circuits 305, and memory 304. The processor 302 may include one or more microprocessors known in the art. The support circuits 305 for the processor 302 include conventional cache, power supplies, clock circuits, data registers, I/O interface 307, and the like. The I/O interface 307 may be directly coupled to the memory 304 or coupled through the support circuits 305. The I/O interface 307 may also be configured for communication with input devices and/or output devices such as network devices, various storage devices, mouse, keyboard, display, video and audio sensors, IMU and the like.

The memory 304, or computer readable medium, stores non-transient processor-executable instructions and/or data that may be executed by and/or used by the processor 302. These processor-executable instructions may comprise firmware, software, and the like, or some combination thereof. Modules having processor-executable instructions that are stored in the memory 304 comprise a detection module 306 and a database 316. The detection module 306 further comprises a gesture input identification module 308, an application identification module 310, an application inspection module 312 and a menu generation module 314.

The computer system 300 may be programmed with one or more operating systems 320, which may include OS/2, Linux, SOLARIS, UNIX, HPUX, AIX, WINDOWS, IOS, and ANDROID among other known platforms.

The memory 304 may include one or more of the following: random access memory, read only memory, magneto-resistive read/write memory, optical read/write memory, cache memory, magnetic read/write memory, and the like, as well as signal-bearing media as described below.

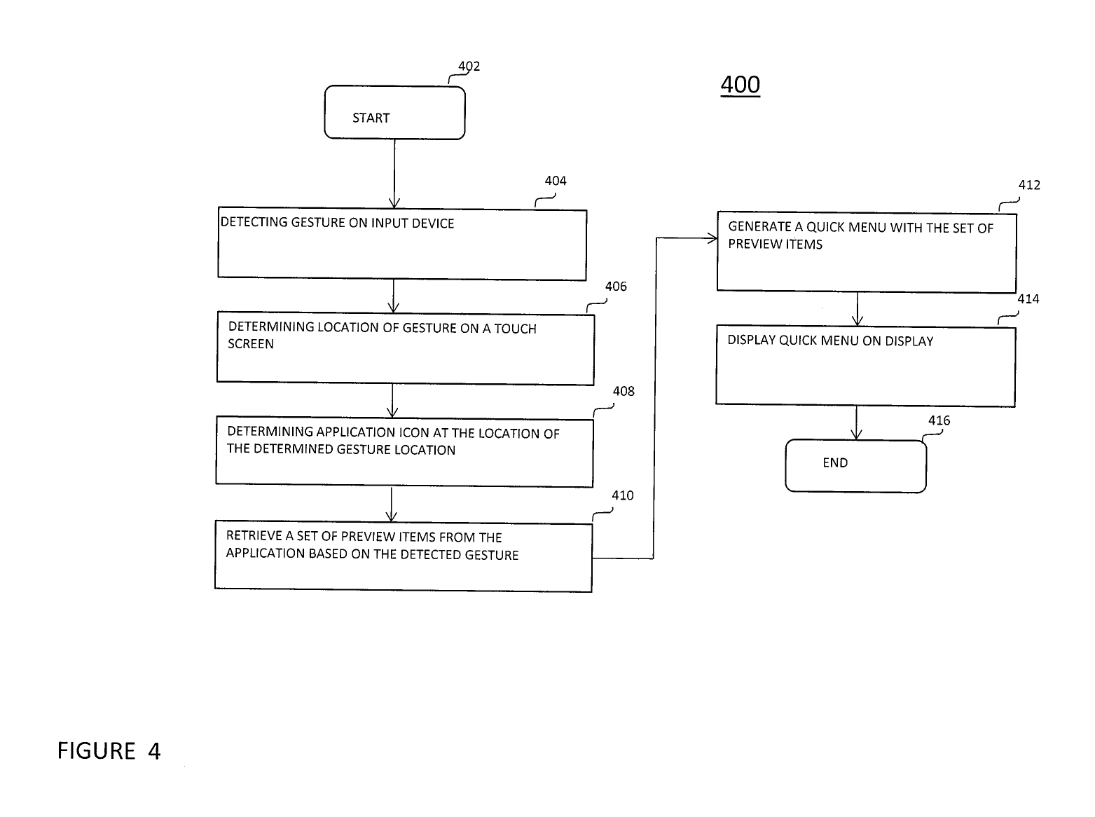

FIG. 4 is a flow diagram depicting a method 400 for generating customized menus for accessing application functionality and information in accordance with exemplary embodiments of the present invention. The method 400 is an exemplary process flow of the detection apparatus 100, implemented as the detection module 306, executed on the computer system 300.

The method begins at step 402 and proceeds to step 404. At step 404, the detection module 306 detects a gesture on an input device. According to exemplary embodiments, the gesture may be detected on a touch screen of a mobile device, or the like. The location of the gesture is registered by the detection module 306. According to other embodiments, the gesture may be detected through a three-dimensional tracking device. A 3D coordinate may similarly be computed based on the location of the gesture start point for a 3D input device such as a MICROSOFT KINECT or the like. Those of ordinary skill in the art would recognize that the detection apparatus may function on any input device or interface.

The method proceeds to step 406, where the gesture input identification module 308 determines the location of the gesture in the coordinate system of the input device. For example, if the input device is a two-dimensional touch surface, and the gesture begins at the top right corner of the touch surface, the pixel location of the gesture start point may be x=500 and y=100, assuming the coordinate system has an origin of x=0 and y=0 at the top left corner of the display.

At step 408, the application identification module 310 identifies which icon is located at the gesture start point. Taking the above example, if the gesture start point is located at x=500 and y=100 (500, 100), then the application identification module 310 determines which application icon covers the pixel at (500,100), currently being displayed. For example, as shown in FIG. 2, an icon for the VOIP APP 208 may be determined to be at location (500,100). Accordingly, the application identification module 310 can retrieve the application related to the icon, i.e., the VOIP APP 208.

Subsequently, the method proceeds to step 410 where the application inspection module 312 inspects the identified application for publicly exposed functionality. For example, if the application is the VOIP APP 208, the application inspection module 312 sends an inspection request to the VOIP APP 208. VOIP APP 208 returns a list of publicly exposed functions to the inspection module 312. VOIP APP 208 may return “recent calls”, “favorites” and “missed calls” as functions that are exposed publicly, meaning that external applications may access this functionality without launching VOIP APP 208. In some embodiments, the preview information is stored in a commonly accessible storage location on the mobile device, for example, in a common file containing application preview information. According to other embodiments, application preview information may be shared via inter-application messages, for example ANDROID “intents” or the like. For example, in ANDROID, a widget on the application launcher bar knows how to display calendar events. When a gesture is completed over the widget, an inter-application message is sent to an application running in the background requesting the most recent five upcoming events. Once the background application sends the events, a foreground app (the application displaying the preview information) displays the events.

At step 412, the menu generation module 314 generates a quick menu containing the public exposed functions of the identified application, or, to follow the above example, VOIP APP 208. The menu generation module 314 may retrieve the preview information from the commonly accessible storage location of the mobile device. According to exemplary embodiments, the quick menu contains “user friendly” names of the publicly exposed functions. For example, if VOIP APP 208 exposes a function called “getMissedCalls( )”, the “friendly name” may be “Missed Calls”. According to some embodiments, the user may configure friendly names for each publicly exposed function, or the identified application may provide the friendly name to the application inspection module 314.

According to one embodiment, the friendly names are shown in the quick menu. Users are then able to select each friendly name, which launches the associated application and executes the public function. For example, the quick menu may contain the item “Missed Calls” and upon selecting “Missed Calls”, the VOIP APP 208 is launched directly into a screen displaying all missed calls.

According to other embodiments, the quick menu contains one or more result items from each of the publicly exposed functions of the identified application. For example, for “Missed Calls”, the first three missed calls are shown directly in the menu beneath the “Missed Calls” heading, for “Favorites”, the first three favorites are displayed beneath the “Favorites” heading, and similarly for other public functions. According to this embodiment, if a user wishes to view all missed calls or favorites, the user may select the appropriate heading, where selection may comprise tapping the heading, or navigating to the heading using a navigation device or the like. At step 414, the menu generation module 314 renders the menu to a display on a device, such as a touch screen on a mobile device, a television, a computer monitor, or the like. Those of ordinary skill in the art will recognize that the quick menu may be displayed on any type of display and may accept input through any available means of input. The method terminates at step 416.

While the foregoing is directed to embodiments of the present invention, other and further embodiments of the invention may be devised without departing from the basic scope thereof, and the scope thereof is determined by the claims that follow.

1. A method for generating customized menus for accessing application functionality of a mobile device comprising:
detecting a gesture performed on a display of the mobile device; and
displaying a quick menu on the display containing preview information pertaining to one or more applications based on the detected gesture.

2. The method of claim 1 further comprising:
displaying the quick menu for a set of applications preconfigured by the user.

3. The method of claim 1 further comprising:
detecting whether the gesture was registered at a location on the display corresponding to a location of an application icon, the application icon associated with an application; and
displaying the quick menu containing functionality from the application.

4. The method of claim 3 further comprising:
customizing the preview information in the quick menu depending on user preference.

5. The method of claim 4 further comprising:
displaying the quick menu containing preview information pertaining to one application.

6. The method of claim 5 further comprising:
inspecting one or more applications for preview information and storing the preview information in a commonly accessible storage location on a mobile device.

7. The method of claim 6 further comprising:
retrieving preview information from the commonly accessible storage location on the mobile device.

8. The method of claim 1 further comprising:
executing one of the one or more applications corresponding to a selection of one of a list of preview items comprising the preview information.

9. The method of claim 1 further comprising:
displaying most recent missed calls in the quick menu.

10. The method of claim 1 further comprising:
displaying most called numbers in the quick menu.

11. The method of claim 1 further comprising:
displaying at least one of most recently viewed books, songs, websites, mini-games, calendar events, favorite callers, and movies in the quick menu.

12. An apparatus for generating customized menus for accessing application functionality on a mobile device comprising:
a detection module;
a menu generation module for generating a quick menu based on a detected gesture performed on the mobile device.

13. The apparatus of claim 12 wherein the detection module detects a gesture performed on a display of the mobile device and the menu generation module further generates the quick menu for applications which are executing in background.

14. The apparatus of claim 12 further comprising:
an application identification module that detects whether the gesture was registered at a location on a touch screen corresponding to a location of an application icon, the application icon associated with an application,
wherein the menu generation further displays a quick menu containing functionality from the application.

15. The apparatus of claim 14 wherein the preview information in the quick menu is customized based on user preference.

16. The apparatus of claim 15 wherein the menu generation module generates the quick menu containing preview information pertaining to one application.

17. The apparatus of claim 16 further comprises an application inspection module that inspects one or more applications stored on a mobile device for preview information and that stores the preview information in a commonly accessible storage location on the mobile device.

18. The apparatus of claim 16 wherein the one or more applications share preview information through inter-application messaging.

19. The apparatus of claim 12 wherein the detection module further is configured to execute one of the one or more applications corresponding to a selection of one of a list of preview items comprising the preview information.

20. The apparatus of claim 12 wherein the menu generation module generates a quick menu that displays most recent missed calls in the quick menu, displays most called numbers in the quick menu and displays at least one of most recently viewed books, songs, websites, or movies in the quick menu.
